(19) United States
(12) Patent Application Publication
(10) Pub. No.: US 2009/0112638 A1
(43) Pub. Date: Apr. 30, 2009

(54) System and Method for Virtual Queuing

(75) Inventors: Heidi J. Kneller, Bellevue, WA (US); Calsee N. Robb, Seattle, WA (US); William A. Harkness, Everett, WA (US); Buddy L. Sharpe, Mill Creek, WA (US); James P. Schalla, Edmonds, WA (US)

Correspondence Address: HARNESS DICKEY & PIERCE, PLC, P.O. BOX 828, BLOOMFIELD HILLS, MI, 48303, US

(73) Assignee: The Boeing Company, Chicago, IL (US)

(21) Appl. No.: 11/927,490

(22) Filed: Oct. 29, 2007

(51) Int. Cl. G06Q 10/00

(52) U.S. Cl. 705/5

(57) ABSTRACT

A system for virtually queuing at least one passenger onboard a mobile platform is provided. The system includes a source of user input that enables the at least one passenger to request to be placed in a virtual line. The system also includes a queuing control module that generates queue data that includes at least one next passenger in the virtual line from a list of the at least one passenger requested to be placed in the virtual line. The system further includes a notification control module that notifies the at least one next passenger that the at least one passenger is next in the virtual line based on an operating condition associated with the mobile platform.

### FIELD

The present disclosure relates generally to organizing passengers onboard a mobile platform, and more particularly to a system and method for virtual queuing of passengers onboard a mobile platform.

### BACKGROUND

The statements in this section merely provide background information related to the present disclosure and may not constitute prior art.

Generally, mobile platforms (such as trains, ships, aircraft and automobiles) have at least one lavatory that is accessible during the operation or travel of the mobile platform. For example, in the case of a commercial aircraft, the aircraft typically includes at least one lavatory that is accessible by passengers and crew onboard the aircraft during the duration of the flight when the fasten seatbelts sign is not active. There may be occasions when a waiting line will form to access the lavatory. The line of passengers waiting for the lavatory may interfere with the movement of the crew and other passengers, and it may be undesirable to have passengers in a waiting line in case the aircraft encounters turbulence. Further, due to disabilities, some passengers may not be physically able to stand in line for the lavatory.

In addition, many mobile platforms (such as trains, ships, aircraft and automobiles) have at least one door that enables ingress and egress to the mobile platform. Typically, long lines may form when passengers desire to exit the mobile platform. In the case of a commercial aircraft, for example, the formation of long lines may inhibit movement through the cabin by crew and may interfere with the ability of certain passengers to timely board a second aircraft to continue on their journey.

### SUMMARY

A system for virtually queuing at least one passenger onboard a mobile platform is provided. The system includes a source of user input that enables the at least one passenger to request to be placed in a virtual line. The system also includes a queuing control module that generates queue data that includes at least one next passenger in the virtual line from a list of the at least one passenger requested to be placed in the virtual line. The system further includes a notification control module that notifies the at least one next passenger that the at least one passenger is next in the virtual line based on an operating condition associated with the mobile platform.

In one implementation, a method of virtually queuing passengers onboard a mobile platform is provided. The method includes generating a virtual line based on at least one user input from at least one passenger seated in a passenger seat onboard the mobile platform. The method also includes queuing at least one next passenger in the virtual line. The method further includes notifying the at least one next passenger in the virtual line based on an operating condition associated with the mobile platform. The method further includes notifying the at least one passenger by changing a visual output of a reading light associated with at least one next passenger, projecting a symbol onto an area occupied by the at least one next passenger, delivering a message through an entertainment system associated with the at least one next passenger, delivering a message to a personal computing device associated with the at least one next passenger, generating a tactile signal in a seat associated with the at least one next passenger, or notifying the at least on passenger by generating a visual signal on a seatbelt associated with the passenger seat of the at least one passenger and combinations thereof.

The present teachings also involves an aircraft. The aircraft provides a fuselage that includes at least one door for exiting the aircraft and at least one lavatory, with exit through the at least one door and access to the at least one lavatory controlled by a virtual queuing control system. The processes queue data which includes a virtual line for exit through the at least one door or access to the at least one lavatory.

A system for virtually queuing at least one passenger onboard an aircraft for access to at least one lavatory or for exiting the aircraft is provided. The system includes a source of user input that enables the at least one passenger to request to be placed in a virtual line to access at least one lavatory onboard the aircraft or to exit the aircraft. The system also includes a source of aircraft layout data that provides a layout of the aircraft, occupant data that indicates whether the lavatory is occupied by one of the passengers on the aircraft and passenger data that indicates whether the at least one passenger who generated the request has a connection after the arrival of the aircraft. The system also includes a location control module that determines a location of a passenger seat of the at least one passenger based on the request and determines a location of a lavatory nearest the passenger seat based on the location of the passenger seat and the layout of the aircraft. The system also includes a queuing module that generates queue data that includes at least one next passenger in the virtual line from a list of the at least one passenger requested to be placed in the virtual line. The queue data is based on the occupant data and the list associated with the at least one lavatory, and the queuing module updates the list or generates a new list based on the occupant data and the virtual line associated with the at least one lavatory. The system further includes a flight control module that determines, based on an operating condition, whether to delay exit from the mobile platform the operating condition selected from the group comprising an operating condition in which the passengers are requested to fasten a seatbelt coupled to a seat on the aircraft, an input from a crew member of the aircraft, an operating condition of the lavatory, and combinations thereof. The system further includes a notification module that receives the queue data and notifies the at least one next passenger that the at least one passenger is next in the virtual line if the flight control module does not determine to delay access to the at least one lavatory or to delay exit from the aircraft. The notification module further notifies the at least one next passenger that the at least one passenger is next in the virtual line by one of the following: a change in a reading light associated with at least one next passenger, a symbol projected onto an area occupied by the at least one next passenger, a message delivered through an entertainment system associated with the at least one next passenger, a message delivered to a personal computing device associated with the at least one next passenger, a tactile signal in a seat associated with the at least one next passenger, an auditory signal delivered in range of the at least one next passenger, a visual signal on a seatbelt associated with a seat of the at least one passenger and combinations thereof.

A method of virtually queuing passengers onboard an aircraft for access to at least one lavatory or for exiting the aircraft is provided. The method includes generating a virtual line to access the at least one lavatory on the aircraft or to exit the aircraft based on at least one user input from at least one passenger seated in a passenger seat onboard the aircraft. The method also includes providing a layout of the aircraft that includes a location of the at least one lavatory and the location of the passenger seat, and a source of passenger data that indicates whether the at least one passenger who generated the request has a connection after the arrival of the mobile platform. The method also includes providing an occupant sensor in the at least one lavatory, and sensing if the lavatory is occupied by one of the passengers on the aircraft. The method comprises determining a location of the passenger seat from the layout, determining a location of a lavatory nearest the passenger seat based on the location of the passenger seat and the layout, and queuing the at least one passenger that the lavatory nearest the passenger seat is available if the occupant sensor in the lavatory signals that the lavatory is empty. The method also includes updating the list to include the at least one passenger if the occupant sensor signals that the at least one lavatory is occupied. The method comprises queuing the at least one next passenger to exit the aircraft first if the at least one next passenger has a connection after the arrival of the aircraft, and notifying the at least one next passenger in the virtual line that the at least one next passenger is next to access the lavatory or exit the aircraft. The method includes notifying the at least one next passenger by at least one of the following: changing a visual output of a reading light associated with at least one next passenger, projecting a symbol onto an area occupied by the at least one next passenger, delivering a message through an entertainment system associated with the at least one next passenger, delivering a message to a personal computing device associated with the at least one next passenger, generating a tactile signal in a seat associated with the at least one next passenger, delivering an auditory signal within an auditory range of the at least one next passenger, notifying the at least one passenger by generating a visual signal on a seatbelt associated with the passenger seat of the at least one passenger, and notifying the at least one next passenger through combinations thereof.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a schematic illustration of a mobile platform incorporating the system and method for virtual queuing according to the principles of the present disclosure;

FIG. 2A is a schematic illustration of a passenger onboard the mobile platform of FIG. 1 interacting with an in-flight entertainment system;

FIG. 2B is a schematic illustration of a lavatory onboard the mobile platform of FIG. 1;

FIG. 3 is a dataflow diagram illustrating an exemplary virtual queueing control system of the present disclosure;

FIG. 4 is a dataflow diagram illustrating an exemplary queueing system of the present disclosure;

FIG. 5 is a schematic illustration of the passenger onboard the mobile platform of FIG. 1 receiving a notification according to the principles of the present disclosure;

FIG. 5A is a schematic illustration of the passenger onboard the mobile platform of FIG. 1 receiving a notification according to the principles of the present disclosure;

FIG. 5B is a schematic illustration of the passenger onboard the mobile platform of FIG. 1 without a notification;

FIG. 5C is a schematic illustration of the passenger onboard the mobile platform of FIG. 1 receiving a notification according to the principles of the present disclosure;

FIG. 5D is a schematic illustration of a notification displayed by the in-flight entertainment system;

FIG. 5E is a schematic illustration of a notification delivered by a passenger seat onboard the mobile platform;

FIG. 5F is a schematic illustration of a notification received through a personal electronic device;

FIG. 5G is a schematic illustration of a notification received on a personal computing device;

FIG. 6 is a dataflow diagram illustrating an exemplary notification system according to the principles of the present disclosure;

FIG. 7 is a flowchart illustrating an operational sequence for the virtual queuing control system of FIG. 3;

FIG. 8 is a flowchart illustrating an operational sequence for the virtual queuing control system of FIG. 3; and

FIG. 9 is a flowchart illustrating an operational sequence for the virtual queuing control system of FIG. 3.

### DETAILED DESCRIPTION

The following description is merely exemplary in nature and is not intended to limit the present disclosure, application, or uses. Although the following description is related generally to a system and method for virtual queuing for a mobile platform (such as an aircraft, ship, spacecraft, train or land-based motor vehicle), it will be understood that the system and method for virtual queuing, as described and claimed herein, may be used with any appropriate application where it would be desirable to organize a large group of people, such as in a restaurant or airport. Therefore, it will be understood that the following discussion is not intended to limit the scope of the appended claims to only mobile platforms.

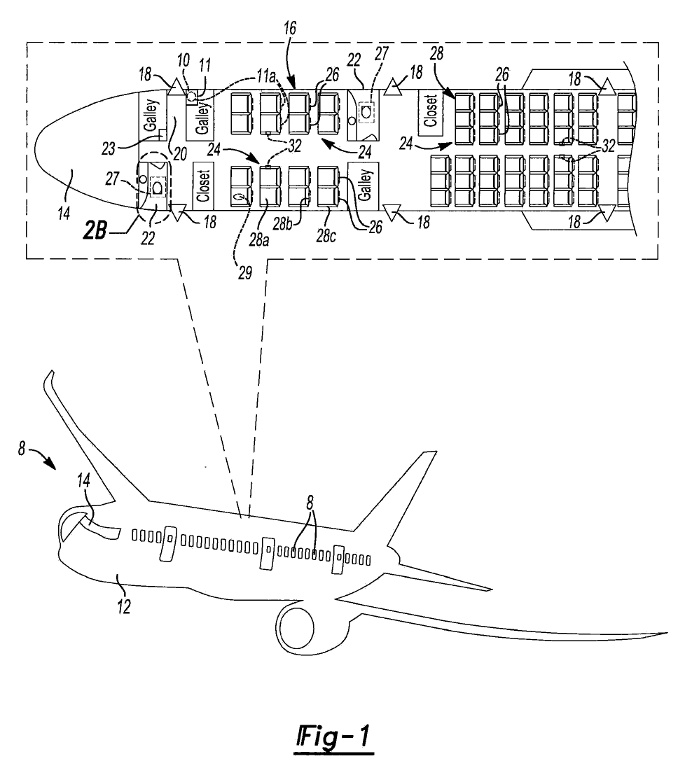

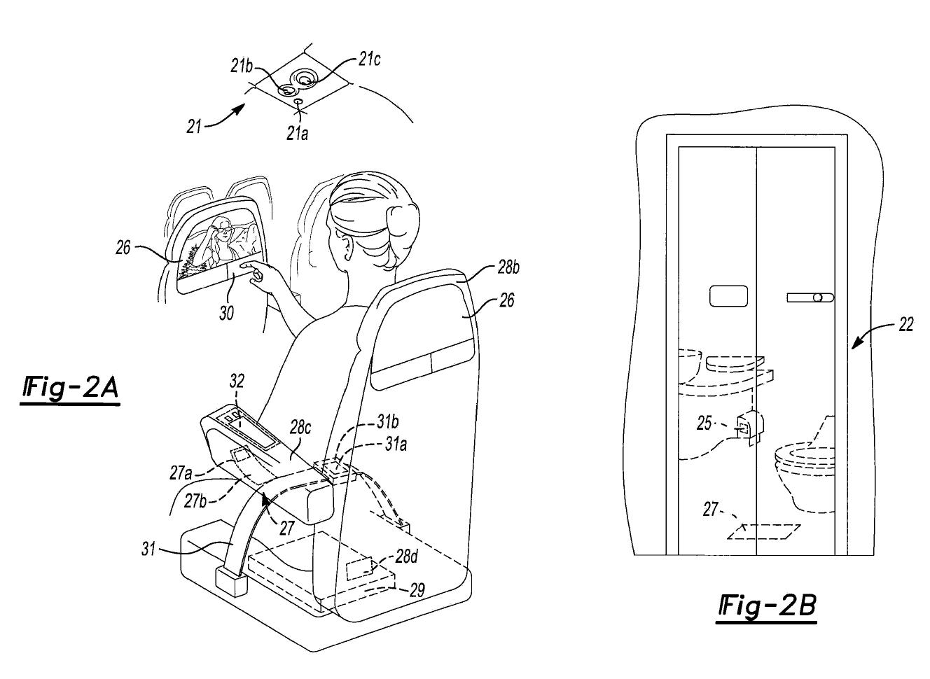

With reference to FIG. 1, a schematic illustrates an exemplary aircraft 8 that employs a system and a method for virtual queuing through a virtual queuing control module 10. The aircraft 8, in this example, is a passenger aircraft 8 that includes a cockpit 14, a cabin 16 and at least one door 18 for ingress and egress. The cabin 16 includes a controller 11, at least one crew area 20, at least one lavatory 22 and at least one passenger seating system 24. The controller 11 may comprise a computer and/or processor, and memory to hold instruction and data related to the virtual queuing control module 10. As shown in FIG. 2A, the cabin 16 may also include a passenger service unit (PSU) 21 that can enable the passenger to contact a crew member via an attendant call button 21a, adjust an air flow through a gasper 21b and/or activate a reading light 21c, as is generally known. The PSU 21 is in communication with and responsive to the controller 11 through either a wired or wireless connection (not specifically shown).

Returning to FIG. 1, he at least one crew area 20 may include a control panel 23 that can enable the crew to interface with the virtual queuing control module 10. Thus, the control panel 23 may include at least one user input device and display means, such as a GUI for example, however, any suitable user input device and display means could be employed, such as button(s) and a display screen. The control panel 23 is in communication with and responsive to the controller 11 through either a wired or wireless connection (not specifically shown). As shown in FIG. 2 the lavatory 22 may include at least one condition sensor 25 and at least one occupant sensor 27. The condition sensor 25 and the occupant sensor 27 may each be in communication with and responsive to the controller 111 through either a wired or wireless connection (not specifically shown). The condition sensor 25 may monitor a condition of the lavatory 22, such as whether the lavatory 22 is out of toilet paper, lotion, etc. The occupant sensor 27 may generate a signal that indicates whether the lavatory 22 is occupied. Thus, the occupant sensor 27 could comprise one or more of a weight sensor, RFID sensor, ticket reader, lock bolt sensor, flush sensor, etc.

With reference to FIGS. 1 and 2, the passenger seating system 24 may include an in-flight entertainment system 26 and a seat assembly 28. As shown in FIG. 2, the in-flight entertainment system 26 may include an input device 30, such as a GUI, a touch screen, a button, a touch pen, a keyboard, a joystick, a mouse or any other suitable user input device that enables a passenger to interface with the in-flight entertainment system 26. The in-flight entertainment system 26 is in communication with and responsive to the controller 11 through either a wired or wireless connection (an exemplary connection 11a is shown in phantom in FIG. 1). The in-flight entertainment system 26 may occupy the passenger during the operation of the aircraft 8 by providing content to the passenger, such as media, games, etc. The seat assembly 28 includes a seatbelt 31, a seat cushion 28a, a seat back 28b, an armrest 28c and a seat sensor 28d. As the seat assembly 28 may be any seat assembly known in the art, the seat assembly 28 will not be discussed in great detail herein. Briefly, however, the seatbelt, when fastened, may secure the passenger to the seat assembly 28. The seatbelt 31 includes a light source 31a on an outward facing surface 31b that is responsive to and in communication with the controller 11 through either wired or wireless connection (not specifically shown), to light up or change the color of light source 31a in response to a signal from the controller 11. The seat cushion 28a may include a vibration device 29, such as a motor, that is responsive to and in communication with the controller 11, through either wired or wireless connection (not specifically shown), to vibrate the seat cushion 28a in response to a signal from the controller 11. The armrest 28c may include an input device 32, such as a GUI, a touch screen, a button, a touch pen, a keyboard, a joystick, a mouse or any other suitable user input device that is in communication with and responsive to the controller 11 through a wired or wireless connection (not specifically shown). The seat sensor 28d may be in communication with and responsive to the controller 11 to generate a signal that indicates if the seat assembly 28 is occupied. The in-flight entertainment system 26, armrest 28c and/or PSU 21 may enable a passenger to interface with the virtual queuing control module 10.

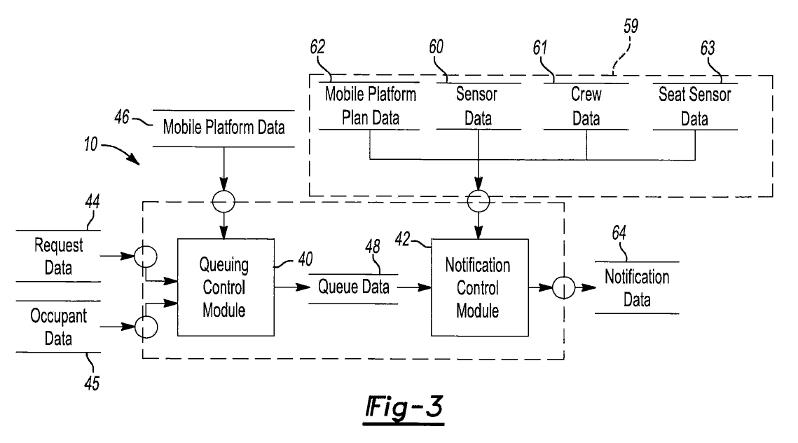

With reference to FIG. 3, the virtual queuing control module 10 for the aircraft 8 is illustrated in accordance with the teachings of the present disclosure. The virtual queuing control module 10 enables the organization of passengers on the aircraft 8 for use of the lavatory 22 and for deplaning through the desired exit door 18. In this regard, the virtual queuing control module 10 operates to efficiently coordinate the use of the lavatory 22 without requiring passengers to line up or wait outside of the lavatory 22. This enables the crew to use the aisles without interference from passengers while also ensuring that the passengers remain seated until they are queued to use the lavatory 22, as will be discussed. The virtual queuing control module 10 also optimizes passenger usage by coordinating passenger seat location with the lavatory 22 available nearest their seat assembly 28. The virtual queuing control module 10 also allows the efficient deplaning of the aircraft 8 as it enables passengers who have to catch a connecting flight to deplane first, thereby reducing the chance that a passenger will miss their connecting flight, as will be discussed.

As used herein, the term “module” refers to an application specific integrated circuit (ASIC), an electronic circuit, a processor (shared, dedicated, or group) and memory that executes one or more software or firmware programs, to a combinational logic circuit, and/or to other suitable components that provide the described functionality. In FIG. 3, a dataflow diagram illustrates various components of a virtual queuing system that is embedded within the virtual queuing control module 10. Various embodiments of the virtual queuing control module 10 may include any number of sub-modules embedded within the virtual queuing control module 10. The sub-modules shown in FIG. 3 may be combined and/or further partitioned to similarly control the queuing of the passengers onboard the aircraft 8. Inputs to the virtual queuing control module 10 are received from other control modules (not shown) within the aircraft 8, and/or determined by other sub-modules (not shown) within the virtual queuing control module 10 (not shown). The virtual queuing control module 10 may also be embedded with other processing units with in the aircraft architecture while still serving the purpose described herein. In FIG. 3, the virtual queuing control module 10 includes a queuing control module 40 and a notification control module 42.

The queuing control module 40 receives as input request data 44, occupant data 45 and aircraft or mobile platform data 46. The input request data 44 comprises input from the passenger(s) received through either of the user input devices 30, 32, as will be discussed. The occupant data 45 comprises data generated by the occupant sensor 27 in the lavatory 22 that is indicative of whether a passenger is in the lavatory 22. The aircraft data 46 comprises a model of the aircraft 8, a flight plan for the aircraft 8, such as a flight schedule status and anticipated turbulence, data associated with the passengers on the aircraft 8, such as whether the passenger has a connecting flight, for example, and data associated with the crew in-flight service schedule, which may be updated substantially in real-time. Based on the request data 44, the occupant data 45 and the aircraft data 46, the queuing control module 40 sets queue data 48 for the notification control module 42. The queue data 48 comprises the passenger(s) next in line for a particular lavatory 22 or the passenger(s) next in line to deplane or exit the aircraft 8.

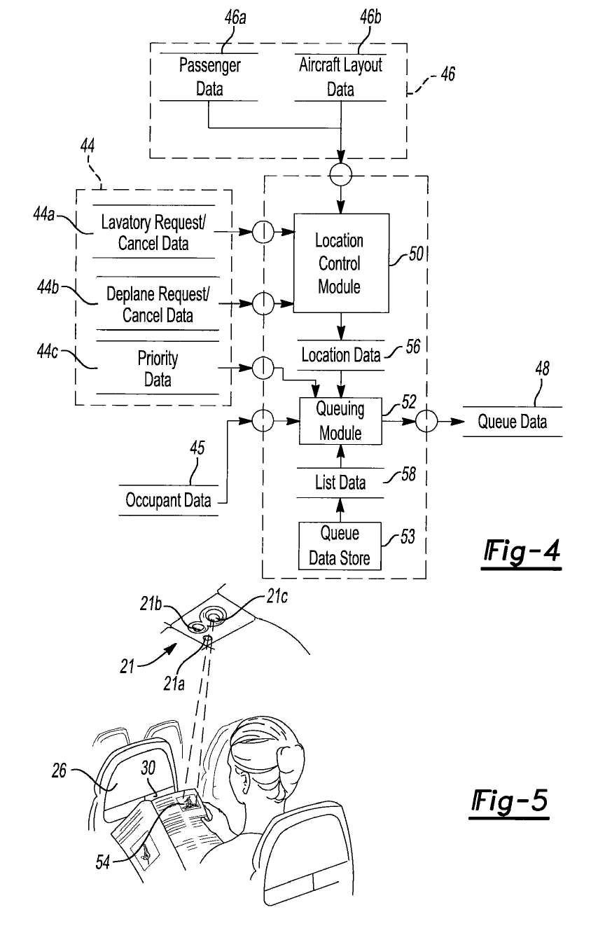

With reference to FIG. 4, a dataflow diagram illustrates an exemplary queuing system that may be embedded within the queuing control module 40. The queuing control module 40 includes a location control module 50, a queuing module 52 and a queue data store 53. The location control module 50 receives as input the request data 44 and the aircraft data 46. The request data 44 may comprise bathroom request/cancel data 44a and/or deplane request/cancel data 44b. The bathroom request/cancel data 44a and deplane request/cancel data 44b may be received via the user input devices 30, 32, as shown in FIG. 2.

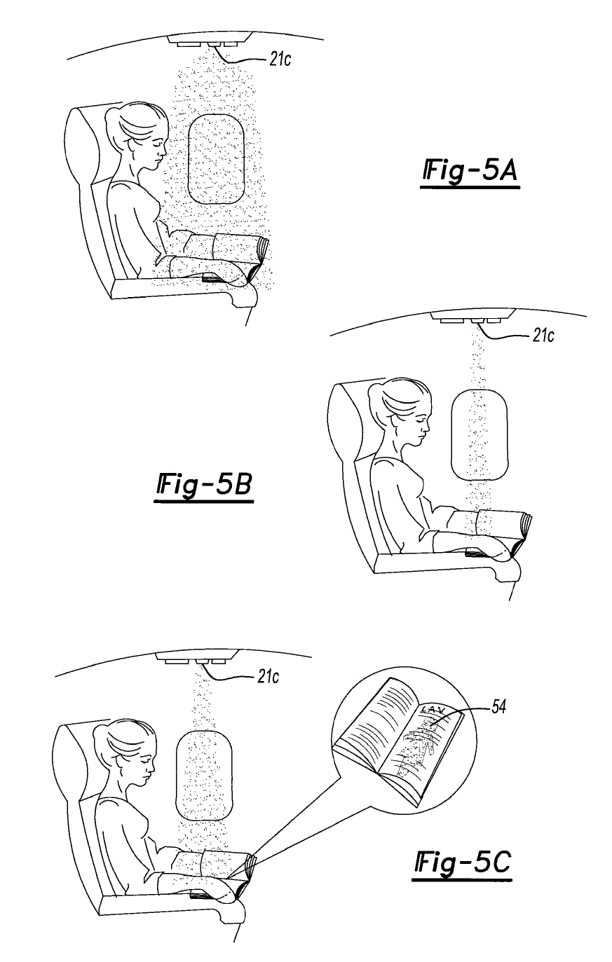

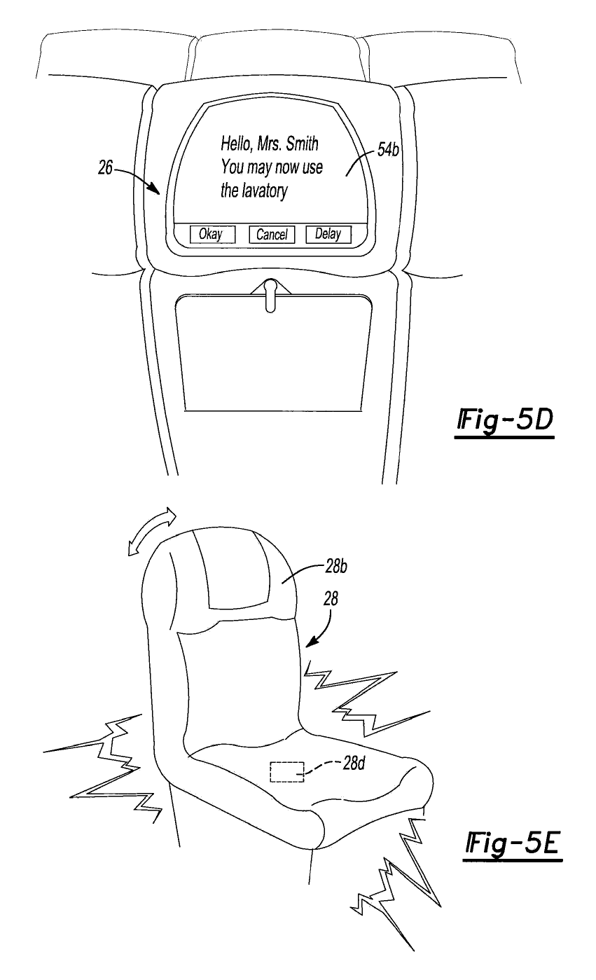

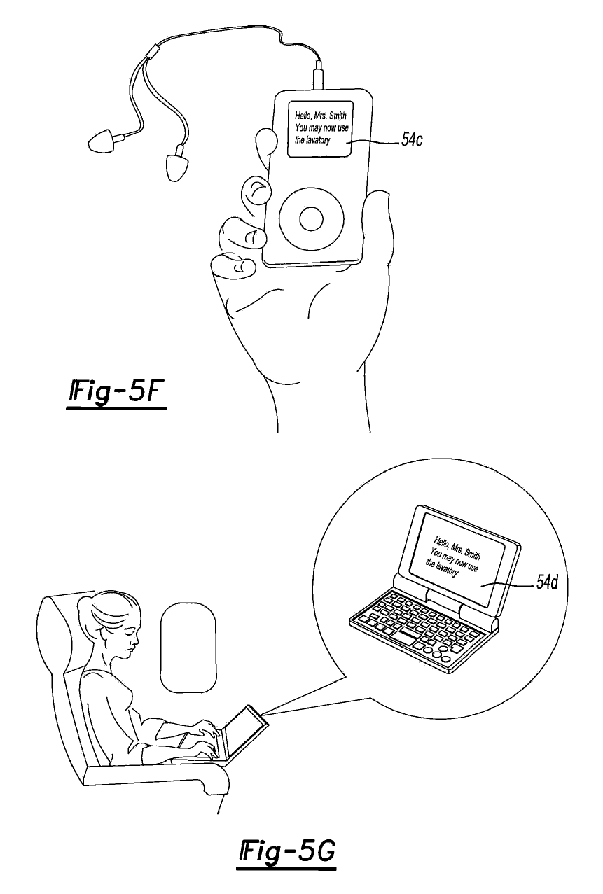

With reference to FIG. 4, the bathroom request/cancel data 44a comprises a request by the passenger to use the lavatory 22, and may comprise a desired method of notification when the passenger is next in line. The bathroom request/cancel data 44a may also comprise a cancellation request from the passenger to cancel a prior request to use the lavatory 27. The bathroom request/cancel data 44a may comprise a request from the passenger to know the approximate number of passengers in line for the lavatory 22 in front of the passenger. With regard to the desired method of notification, with reference to FIG. 5, for example, the passenger may specify to be notified by the reading light, via a projected symbol 54, for example. With reference to FIG. 5A, the projected symbol 54 may be projected to encompass a substantial portion of a passenger space 54a, in contrast to a regular projection of the reading light 21c as shown in FIG. 5B. As shown in FIG. 5C, the projected symbol 54 may be projected from the reading light 21c onto reading material of the passenger such that the projected symbol 54 encompasses a large portion of the reading material. Further, the desired method of notification could comprise a request to be notified through the in-flight entertainment system 26, via a graphical user interface (GUI), such as a pop-up message, as shown in FIG. 5D, tactile notification, such as by the vibration device 29 in the seat cushion 28a, as shown in FIG. 5E, a return of the seat back 28b to a standard position from a reclined position (not shown) or a visual signal, such as the illumination of the light source 31a on the seatbelt 31. The desired method of notification could comprise a request to be notified by an audible signal, such as a tone or message played through headphones in communication with the in-flight entertainment system 26, or through an audible signal transmitted to a personal electronic device of the passenger, such as an IPod™ (available from Apple, Inc. of Cupertino, Calif.) as shown in FIG. 5F. Alternatively, if the passenger is in communication with an intranet onboard the aircraft 8 via a personal computing device, such as a laptop, personal data assistant (PDA) or the like, then the passenger could request to be notified via a GUI or pop-up message displayed on their personal computing device, as shown in FIG. 5G. The bathroom request/cancel data 44a may also provide data indicative of a “bathroom emergency” in which time is of the essence. For example, in the case of a “bathroom emergency”, the passenger may cancel the request to use the lavatory 22 and go directly to the lavatory 22.

The deplane request/cancel data 44b may be received via the user input devices 30, 32, and comprises a request by the passenger to deplane first or last, for example. In this regard, the deplane request/cancel data 44b may comprise a request by the passenger to deplane first because they have a connecting flight that is scheduled to depart within a close proximity to the arrival time of the aircraft 8, as verified by the aircraft data 46, and further, may indicate if the passenger with the connecting flight requires assistance to exit the aircraft 8. The deplane request/cancel data 44b may also comprise a request by the passenger to deplane last, as the passenger may require assistance to exit the aircraft 8.

The aircraft data 46 is also received by the location control module 50. The aircraft data 46 comprises passenger data 46a and aircraft layout data 46c. The passenger data 46a may provide the names of the passengers and the assigned seats for the passengers on the aircraft 8. The passenger data 46a may also include data regarding whether the passenger has a connecting flight and the scheduled departure time for the connecting flight. The passenger data 46a may also include a zone of the aircraft 8 the passenger is located in. The aircraft layout data 46b comprises data regarding the layout of the aircraft 8, such as a location of the seat assemblies 28, a location of the egress door 18 and locations of the lavatory or lavatories 22.

Based on the bathroom request/cancel data 44a, deplane request/cancel data 44b, passenger data 46a and aircraft layout data 46b, the location control module 50 sets location data 56 for the queuing module 52. The location data 56 may comprise the location of the passenger making the request, the notification method desired by the passenger and the lavatory 22 nearest the passenger, and in some cases the current zone location of the passenger.

The queuing module 52 receives as input the location data 56, the occupant data 45 and list data 58. The list data 58 comprises the next passenger on the list for a given lavatory 22, or the next passenger(s) to deplane. Based on the location data 56, the queuing module 52 queries the queue data store 53 for the list data 58. The queue data store 53 may comprise one or more data storage devices and may be at least one of random access memory (RAM), read only memory (ROM), a cache, a stack, or the like which may temporarily or permanently store electronic data. The queue data store 53 stores electronic data associated with the queue or wait list for each of the lavatories 22 and for deplaning. Thus, the queue data store 53 may comprise electronic data that includes a list of passengers virtually in line for a particular lavatory 22, and a list of passengers in line to deplane first or last. Based on the location data 56, occupant data 45 and the list data 58, the queuing module 52 outputs the queue data 48. The queue data 48 comprises the next passenger(s) on the list, and if applicable, the desired notification method for the passenger(s), which may include priority data associated with the use of the lavatory 22.

With reference to FIG. 3, the notification control module 42 receives the queue data 48. The notification control module 42 also receives as input operating condition data 59, such as sensor data 60, crew data 61 and mobile platform data 62. The sensor data 60 may comprise input from the condition sensor 25 in the lavatory 22, such as a signal indicative that the lavatory 22 is out of toilet paper. The sensor data 60 may also comprise data from the seat sensor 28d, which indicates if the passenger is not at his/heir seat assembly 28. The crew data 61 may comprise a request to delay the queuing of passenger(s). For example, a crew member might request to delay queuing of passengers during food and beverage service, or in the case of unexpected turbulence. Further, a crew member might request to delay queuing to service the lavatory 22 or to prevent the use of the lavatory 22 in the case of a malfunction. The crew might also request a delay if there are problems with preparing the cabin for deplaning, if the passenger(s) are slow to deplane, etc. The crew data 61 may be provided through the control panel 23 in the crew area 20. The mobile platform data 62 may comprise the travel time for the aircraft 8, along with the anticipated intervals in which passengers will be instructed to wear their seatbelts, such as during periods of turbulence and in preparation for landing and departure.

Based on the queue data 48, the sensor data 60, the crew data 61 and the mobile platform data 62, the notification control module 42 outputs notification data 64. The notification data 64 is operable to notify the passenger(s), through the desired means, if applicable, that they are next in line for the lavatory 22 or to deplane. The notification method for indicating that the passenger(s) is next for the lavatory 22 may be provided through the request data 44 entered via the user input devices 30, 32. Generally, the notification data 64 for indicating that a particular passenger(s) is to deplane may be a pre-selected uniform notification method, which can be selected by an airline that operates the aircraft 8. For example, the standard notification method could comprise a change in color in the reading light associated with the passenger(s) that is next to deplane, i.e. the reading light could turn green, etc. It should be noted that, although not specifically illustrated, the notification control module 42 may receive user input after notification of the passenger that comprises a request from the passenger to be requeued for the lavatory 22 so that the passenger may finish a desired task, such as drinking, eating, watching a movie, etc.

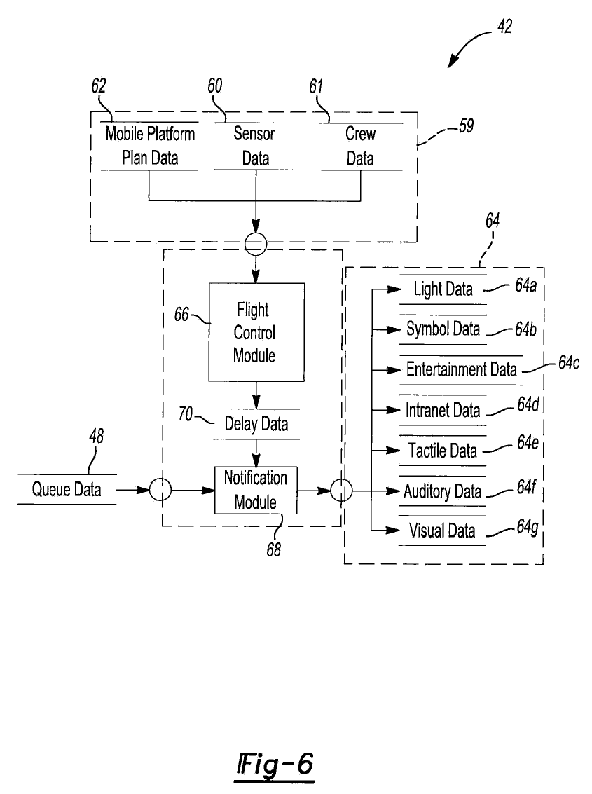

With reference to FIG. 6, a dataflow diagram illustrates an exemplary notification system that may be embedded within the notification control module 42. The notification control module 42 may include a flight control module 66 and a notification module 68. The flight control module 66 receives the sensor data 60, crew data 61 and the mobile platform data 62 as input. Based on the sensor data 60, crew data 61 and the mobile platform data 62, the notification control module 42 sets delay data 70 for the notification module 68. The delay data 70 may comprise data indicative of whether the next passenger should be queued. In this regard, in the case of a lavatory request, if the sensor data 60 indicates that attention is needed in the lavatory 22, an attendant has requested a delay in queuing the next passenger or if the mobile platform data 62 indicates that the fasten seatbelts sign is active, then the delay data 70 comprises a signal to delay the next passenger from using the lavatory 22. In the case of a deplane request, delay data 70 may be generated if the aircraft 8 has not reached the terminal, or if the crew needs additional time to prepare the cabin 16 for deplaning.

The notification module 68 receives the delay data 70, and the queue data 48. Based on the delay data 70 and the queue data 48, the notification module 68 outputs notification data 64 that is indicative of the desired notification method for the passenger(s). The notification data 64 may comprise light data 64a, symbol data 64b, entertainment data 64c, intranet data 64d, tactile data 64e, auditory data 64f, visual data 64g, and combinations thereof. The light data 64a comprises, for example, a change in color of the reading light 21c, while the symbol data 64b can comprise the symbol 54 projected by the reading light 21c onto the passenger, as shown in FIG. 5C. The entertainment data 64c comprises a notification message that is communicated to the passenger(s) over the in-flight entertainment system 26, such as a pop-up message, symbol or other GUI (FIG. 5D). The intranet data 64d comprises a notification message that is communicated to the passenger(s) over the personal computing device of the passenger that is in communication with the intranet on the aircraft 8, and the message may comprise a pop-up message, symbol or other GUI (FIG. 5G). The tactile data 64e comprises a notification message that the passenger(s) feel, such as a vibration in the seat assembly 28 generated by the vibration device 29, or the raising of the seat back 28b of the passenger(s) from the reclined position, for example (FIG. 5E). The auditory data 64f comprises a notification message that is communicated to the passenger(s) via headphones in communication with the in-flight entertainment system 26, or personal electronic device (FIG. 5F) and may comprise a tone or recorded message. The visual data 64g comprises a notification message that is visually communicated to the passenger via the seatbelt 31, such as the illumination of the light source 31a (FIG. 2).

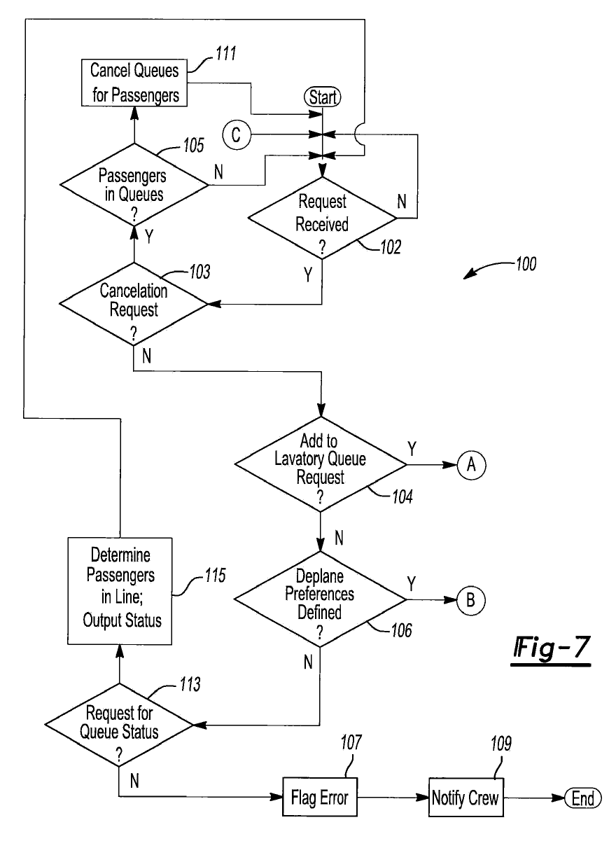

With reference to FIG. 7, a process flow diagram illustrates an exemplary operational sequence 100 performed by the virtual queuing control module 10. At operation 102, the method determines if a request or request data 44 has been received via the user input devices 30, 32. If no request was received, then the method loops until the request data 44 is received. If a request is received, then the method goes to operation 103. In operation 103, the method determines if a cancellation request has been received via the request data 44. If a cancellation request has not been received, the method goes to operation 104. Otherwise, the method goes to operation 105, in which the method determines if the passenger is in queue. If the passenger is in queue for either the lavatory 22 or to deplane, then the method cancels the queues for the passenger in operation 111 before looping to 102. If the passenger is not in queue, then the method goes to 102.

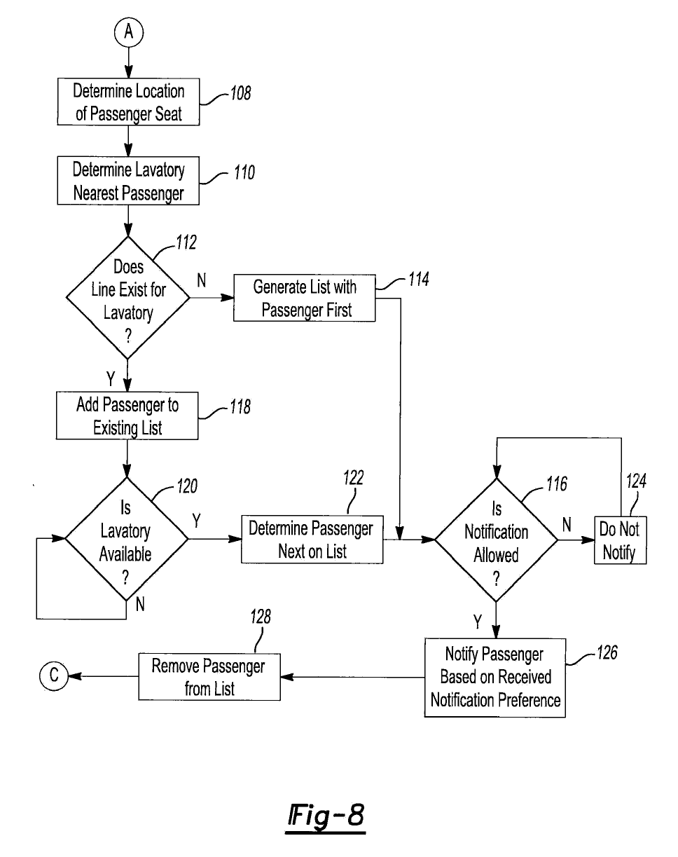

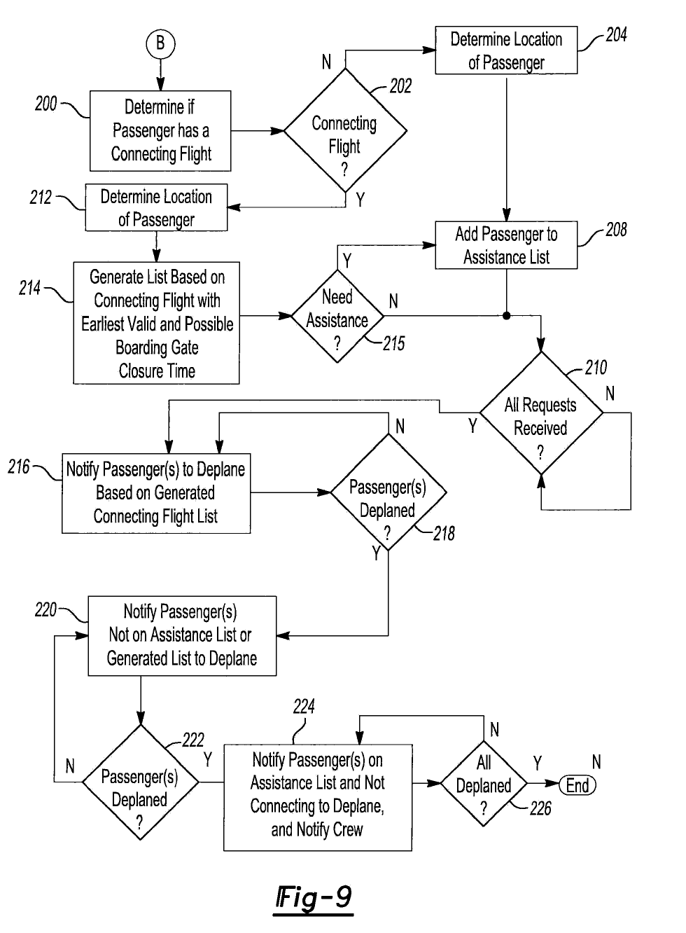

In operation 104, the method determines if the request data 44 comprises bathroom request/cancel data 44a. If the request data 44 comprises bathroom request/cancel data 44a, then the method goes to A on FIG. 8. Otherwise, the method goes to operation 106, in which the method determines if the request data 44 comprises a request to deplane or deplane request/cancel data 44b. If the request data 44 comprises deplane request/cancel data 44b, then the method goes to B on FIG. 9. Otherwise, the method goes to operation 113. At operation 113, the method determines if the passenger request data 44 comprises a request for queue status. If the request data 44 comprises a request for queue status, then the method goes to operation 115. At operation 115, the method determines the number of passengers in line for the lavatory 22 based on the list data 58 and outputs queue status data that comprises the number of passengers ahead of the requesting passenger in line. Then, the method loops to operation 102. If in operation 113 the request data 44 does not comprise a request for que status, then the method goes to operation 107. At operation 107, the method flags an error and notifies the crew at operation 109. Then, the method ends.

With reference to FIG. 8, if the request data 44 comprises bathroom request/cancel data 44a, then at operation 108 the method determines the location of the passenger who initiated the request data 44. The location of the passenger may be determined based on the user input device 30, 32 used to input the request data 44 and the passenger data 46a. The location of the passenger may comprise the location of the seat assembly 28 of the passenger as determined from the user input device 30, 32 or may comprise a zone of the aircraft 8 the passenger is located in, if, for example, the passenger is equipped with a radio frequency identification (RFID) tag (now shown). Next, at operation 110, the method determines the lavatory 22 nearest the passenger based on the passenger seat location or passenger location (if known), and the aircraft model data 46b. At operation 112, the method determines if a list or virtual line exists for that lavatory 22 based on the list data 58. If no virtual line exists for the lavatory 22, then in operation 114 the method generates a list with the requesting passenger at the top of the list. The method then goes to operation 116.

Otherwise, if a virtual line or list data 58 exists for the lavatory 22, then the method adds the passenger to the list in operation 118. It should be noted that if the bathroom request/cancel data 44a indicates that a “bathroom emergency” is present, then the method may add the passenger to the top of the virtual line such that the passenger is the next individual queued for the lavatory 22 nearest the passenger. In operation 120, the method determines if the lavatory 22 is available. The method determines if the lavatory 22 is available based on the data received from the occupant data 45. If the lavatory 22 is not available, then the method loops until the lavatory 22 is available. If the lavatory 22 is available, then the method goes to operation 122.

In operation 122, the method determines who the next person is on the list for the lavatory 22 based on the list data 58. In operation 116, the method determines if notification of the individual is allowed. The method determines if notification is allowed based on the delay data 70. If the delay data 70 indicates that a delay is requested, then the method goes to operation 124. In operation 124, the method does not notify the individual, and loops until notification is allowed.

Once notification is allowed in operation 126, the method notifies the passenger that the lavatory 22 is available based on the desired notification method received with the bathroom request/cancel data 44a. Then, in operation 128, the method removes the passenger from the list, and thus, updates the list data 58. Next, the method goes to C, on FIG. 7.

With reference to FIG. 7, if the request data 44 comprises deplane request/cancel data 44b, the method goes to B on FIG. 9. With reference to FIG. 9, the method, at operation 200, determines if the passenger has a connecting flight. The method may determine if the passenger has a connecting flight based on the information contained in the passenger data 46a. For example, the connecting flight could be entered by the passenger and verified by the airline operating the aircraft 8. At operation 202, if the passenger does not have a connecting flight, then at operation 204, the method determines the location of the passenger seat based on the deplane request/cancel data 44b and the aircraft model data 46b. Then, at operation 208, the method adds the passenger to a list of passenger(s) needing assistance in order to exit the aircraft 8. The method goes to operation 210.

Otherwise, if, at operation 202, the passenger has a connecting flight, then the method goes to operation 212. At operation 212, the method determines the location of the passenger seat, based on the location of the user input device 30, 32 used to enter the deplane request/cancel data 44b, and the aircraft model data 46b. At operation 214, the method generates a connecting flight list that includes passenger(s) ordered based on the connecting flight and the departure time of the connecting flight, which may be updated in real-time. The method then goes to operation 215. At operation 215, the method determines if the passenger with the connecting flight also needs assistance. If assistance is requested, then the method goes to operation 208. Otherwise, the method goes to operation 210.

At operation 210, the method determines if all deplane request/cancel data 44b has been received for the aircraft 8. This could be determined based on the expiration of a period of time, for example. If all of the deplane request/cancel data 44b has not been received, then the method loops. Otherwise, the method goes to operation 216. At operation 216, the method notifies passenger(s) to deplane based on the list data 58 for the virtual line to deplane generated. The passenger(s) may be notified by the notification data 64 through any appropriate means, such as through the reading light, audible tones, etc., as discussed herein. Then, in operation 218, the method determines whether all the passenger(s) with connecting flights have deplaned. The method may determine if all the passenger(s) have deplaned based on the delay data 70. In this regard, if no delay data 70 is received, such as through the crew requesting a delay to enable the remaining passenger(s) to exit, then the method may go to operation 220. In addition, it should be noted that the method may determine that all passenger(s) with connecting flights have deplaned based on the expiration of a pre-selected time period. If all of the passenger(s) have not deplaned, then the method loops to operation 216. Otherwise, the method goes to operation 220.

At operation 220, the method notifies passenger(s) not on the assistance list or the generated list of passenger(s) with connecting flights to deplane. The passenger(s) may be notified through any appropriate means, such as through the reading light, audible tones, etc., as discussed herein. Then, the method goes to operation 222. At operation 222, the method determines if all of the passenger(s) not requiring assistance have deplaned. The method may determine if all the passenger(s) not requiring assistance have deplaned based on the delay data 70 and/or the expiration of a pre-selected time period, however, any suitable technique could be employed. If the passenger(s) not requiring assistance have not all deplaned, then the method loops to operation 220. Otherwise, the method goes to operation 224.

At operation 224, the method notifies passenger(s) on the assistance list to deplane and may notify the crew to assist the passenger(s) on the assistance list. The passenger(s) may be notified through any appropriate notification data 64, such as through the reading light, audible tones, etc., as discussed herein. The crew may be notified through the control panel 23, for example. Then, the method goes to operation 226. At operation 226, the method determines if all of the passenger(s) have deplaned. The method may determine if all the passenger(s) have deplaned based on the delay data 70 and/or the expiration of a pre-selected time period, however, any suitable technique could be employed. If the passenger(s) have not all deplaned, then the method loops to operation 224. Otherwise, the method ends.

While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

What is claimed is:

1. A system for virtually queuing at least one passenger onboard a mobile platform comprising:
a source of user input that enables the at least one passenger to request to be placed in a virtual line;
a queuing control module that generates queue data that includes at least one next passenger in the virtual line from a list of the at least one passenger requested to be placed in the virtual line; and
a notification control module that notifies the at least one next passenger that the at least one passenger is next in the virtual line based oil an operating condition associated with the mobile platform.

2. The system of claim 1, wherein the virtual line comprises a virtual line to access at least one lavatory on the mobile platform.

3. The system of claim 1, wherein the virtual line comprises a virtual line to exit the mobile platform, and the request comprises one of a request to exit the mobile platform first or a request for assistance to exit the mobile platform.

4. The system of claim 1, wherein the operating condition is selected from the group comprising: an operating condition in which the passengers are requested to fasten a seatbelt coupled to a seat on the mobile platform, an input from a crew member of the mobile platform, and combinations thereof.

5. The system of claim 2, wherein the operating condition is selected from the group comprising: an operating condition in which the passengers are requested to fasten a seatbelt coupled to a seat on the mobile platform, an input from a crew member of the mobile platform, an operating condition of the lavatory, and combinations thereof.

6. The system of claim 2, wherein the queuing control module further comprises:
a source of mobile platform layout data that provides a layout of the mobile platform;
a source of occupant data that indicates whether the lavatory is occupied by one of the passengers on the mobile platform;
a location control module that determines a location of a passenger seat of the at least one passenger based on the request and determines a location of a lavatory nearest the passenger seat based on the location of the passenger seat and the layout of the mobile platform;
a queuing data store that stores the list that includes the virtual line associated with the at least one lavatory;
a queuing module that generates the queue data based on the occupant data and the virtual line associated with the at least one lavatory; and
wherein the queuing module updates the list or generates a new list based on the occupant data and the virtual line associated with the at least one lavatory.

7. The system of claim 6, wherein the queue data is generated if the lavatory is empty, and the queuing module updates the list if the lavatory is occupied.

8. The system of 3, wherein the queuing control module further comprises:
a source of mobile platform layout data that provides a layout of the mobile platform;
a source of passenger data that indicates whether the at least one passenger who generated the request has a connection after the arrival of the mobile platform;
a location control module that determines a location of a passenger seat associated with the at least one passenger based on the request;
a queuing data store that stores the list that includes the virtual line associated with the exit of the mobile platform; and
a queuing module that generates the queue data based on the passenger data and the virtual line associated with the exit of the mobile platform; and
wherein the queuing module updates the list or generates a new list based on the passenger data and the virtual line associated with the exit of the mobile platform.

9. The system of claim 8, wherein the new list is generated if the passenger does not have a connection after the arrival of the mobile platform or the request is for assistance to exit the mobile platform.

10. The system of claim 5, wherein the notification control module further comprises:
a flight control module that determines, based on the operating condition, whether to delay access to the at least one lavatory; and
a notification module that receives the queue data and notifies the at least one next passenger that the at least one passenger is next in the virtual line if the flight control module does not determine to delay access to the at least one lavatory.

11. The system of claim 4, wherein the notification control module further comprises:
a flight control module that determines, based on the operating condition, whether to delay exit from the mobile platform; and
a notification module that receives the queue data and notifies the at least one next passenger that the at least one passenger is next in the virtual line if the flight control module does not determine to delay exit from the mobile platform.

12. The system of claim 1, wherein the notification control module notifies the at least one next passenger that the at least one passenger is next in the virtual line by one of the following: a change in a reading light associated with at least one next passenger, a symbol projected onto an area occupied by the at least one next passenger, a message delivered through an entertainment system associated with the at least one next passenger, a message delivered to a personal computing device associated with the at least one next passenger, a tactile signal in a seat associated with the at least one next passenger, an auditory signal delivered in range of the at least one next passenger, a visual signal on a seatbelt associated with a seat of the at least one passenger and combinations thereof.

13. A method of virtually queuing passengers onboard a mobile platform comprising:
generating a virtual line based on at least one user input from at least one passenger seated in a passenger seat onboard the mobile platform;
queuing at least one next passenger in the virtual line; and
notifying the at least one next passenger in the virtual line based on an operating condition associated with the mobile platform, with notifying the at least one next passenger including at least one of the following:
changing a visual output of a reading light associated with at least one next passenger;
projecting a symbol onto an area occupied by the at least one next passenger;
delivering a message through an entertainment system associated with the at least one next passenger;
delivering a message to a personal computing device associated with the at least one next passenger;
generating a tactile signal in a seat associated with the at least one next passenger;
delivering an auditory signal within an auditory range of the at least one next passenger;
notifying the at least one passenger by generating a visual signal on a seatbelt associated with the passenger seat of the at least one passenger; and
notifying the at least one next passenger through combinations thereof.

14. The method of claim 13, wherein generating the virtual line further comprises generating a virtual line to access at least one lavatory on the mobile platform.

15. The method of claim 13, wherein generating the virtual line comprises generating a virtual line to exit the mobile platform, and the request comprises one of a request to exit the mobile platform first or a request for assistance to exit the mobile platform.

16. The method of claim 14, wherein generating the virtual line further comprises:
providing a layout of the mobile platform that includes a location of the at least one lavatory and the location of the passenger seat;
providing an occupant sensor in the at least one lavatory;
sensing if the lavatory is occupied by one of the passengers on the mobile platform;
determining a location of the passenger seat from the layout;
determining a location of a lavatory nearest the passenger seat based on the location of the passenger seat and the layout;
queuing the at least one passenger that the lavatory nearest the passenger seat is available if the occupant sensor in the lavatory signals that the lavatory is empty; and
updating the list to include the at least one passenger if the occupant sensor signals that the at least one lavatory is occupied.

17. The method of 15, wherein the queuing control module further comprises:
providing a source of passenger data that indicates whether the at least one passenger who generated the request has a connection after the arrival of the mobile platform; and
queuing the at least one next passenger to exit the mobile platform first if the at least one next passenger has a connection after the arrival of the mobile platform.

18. An aircraft comprising:
a fuselage that includes at least one door for exiting the aircraft and at least one lavatory, with exit through the at least one door and access to the at least one lavatory controlled by a virtual queuing control system including:
a queuing control module that generates queue data that includes a virtual line for exit through the at least one door or access to the at least one lavatory.

19. The aircraft of claim 18, further comprising
a flight control module that determines, based on an operating condition, whether to delay access to the at least one lavatory or to delay the exit through the at least one door;
a notification module that receives the queue data and notifies the at least one next passenger that the at least one passenger is next in the virtual line if the flight control module does not determine to delay access to the at least one lavatory or exit through the at least one door; and
wherein the notification control module notifies the at least one next passenger that the at least one passenger is next in the virtual line by one of the following: a change in a reading light associated with at least one next passenger, a symbol projected onto an area occupied by the at least one next passenger, a message delivered through an entertainment system associated with the at least one next passenger, a message delivered to a personal computing device associated with the at least one next passenger, a tactile signal in a seat associated with the at least one next passenger, an auditory signal delivered in range of the at least one next passenger, a visual signal on a seatbelt associated with a seat of the at least one passenger and combinations thereof.

20. The system of claim 18, wherein the queuing control module further comprises:
a source of mobile platform layout data that provides a layout of the mobile platform;
a source of occupant data that indicates whether the lavatory is occupied by one of the passengers on the mobile platform;
a source of passenger data that indicates whether the at least one passenger who generated the request has a connection after the arrival of the mobile platform;
a location control module that determines a location of the passenger seat based on the request, and determines a location of a lavatory nearest the passenger seat based on the location of the passenger seat;
a queuing data store that stores the list that includes the virtual line associated with the at least one lavatory and the exit through the at least one door; and
a queuing module that generates the queue data based on the occupant data and the virtual line associated with the at least one lavatory, and generates the queue data based on the passenger data and the virtual line associated with the exit of the mobile platform.

21. A system for virtually queuing at least one passenger onboard an aircraft for access to at least one lavatory or for exiting the aircraft comprising:
a source of user input that enables the at least one passenger to request to be placed in a virtual line to access at least one lavatory onboard the aircraft or to exit the aircraft,
a source of aircraft layout data that provides a layout of the aircraft, occupant data that indicates whether the lavatory is occupied by one of the passengers on the aircraft and passenger data that indicates whether the at least one passenger who generated the request has a connection after the arrival of the aircraft;
a location control module that determines a location of a passenger seat of the at least one passenger based on the request and determines a location of a lavatory nearest the passenger seat based on the location of the passenger seat and the layout of the aircraft;
a queuing module that generates queue data that includes at least one next passenger in the virtual line from a list of the at least one passenger requested to be placed in the virtual line, the queue data based on the occupant data and the list associated with the at least one lavatory, the queuing module updates the list or generates a new list based on the occupant data and the virtual line associated with the at least one lavatory;
a flight control module that determines, based on an operating condition, whether to delay exit from the mobile platform the operating condition selected from the group comprising: an operating condition in which the passengers are requested to fasten a seatbelt coupled to a seat on the aircraft, an input from a crew member of the aircraft, an operating condition of the lavatory, and combinations thereof;
a notification module that receives the queue data and notifies the at least one next passenger that the at least one passenger is next in the virtual line if the flight control module does not determine to delay access to the at least one lavatory or to delay exit from the aircraft; and
the notification module notifies the at least one next passenger that the at least one passenger is next in the virtual line by one of the following: a change in a reading light associated with at least one next passenger, a symbol projected onto an area occupied by the at least one next passenger, a message delivered through an entertainment system associated with the at least one next passenger, a message delivered to a personal computing device associated with the at least one next passenger, a tactile signal in a seat associated with the at least one next passenger, an auditory signal delivered in range of the at least one next passenger, a visual signal on a seatbelt associated with a seat of the at least one passenger and combinations thereof.

22. A method of virtually queuing passengers onboard an aircraft for access to at least one lavatory or for exiting the aircraft comprising:
generating a virtual line to access the at least one lavatory on the aircraft or to exit the aircraft based on at least one user input from at least one passenger seated in a passenger seat onboard the aircraft;
providing a layout of the aircraft that includes a location of the at least one lavatory and the location of the passenger seat, and a source of passenger data that indicates whether the at least one passenger who generated the request has a connection after the arrival of the mobile platform;
providing an occupant sensor in the at least one lavatory;
sensing if the lavatory is occupied by one of the passengers on the aircraft;
determining a location of the passenger seat from the layout;
determining a location of a lavatory nearest the passenger seat based on the location of the passenger seat and the layout;
queuing the at least one passenger that the lavatory nearest the passenger seat is available if the occupant sensor in the lavatory signals that the lavatory is empty;
updating the list to include the at least one passenger if the occupant sensor signals that the at least one lavatory is occupied;
queuing the at least one next passenger to exit the aircraft first if the at least one next passenger has a connection after the arrival of the aircraft; and
notifying the at least one next passenger in the virtual line that the at least one next passenger is next to access the lavatory or exit the aircraft by at least one of the following:
changing a visual output of a reading light associated with at least one next passenger;
projecting a symbol onto an area occupied by the at least one next passenger;
delivering a message through an entertainment system associated with the at least one next passenger;
delivering a message to a personal computing device associated with the at least one next passenger;
generating a tactile signal in a seat associated with the at least one next passenger;
delivering an auditory signal within an auditory range of the at least one next passenger;
notifying the at least one passenger by generating a visual signal on a seatbelt associated with the passenger seat of the at least one passenger; and
notifying the at least one next passenger through combinations thereof.
